(19) United States
(12) Patent Application Publication
(10) Pub. No.: US 2025/0323678 A1
(43) Pub. Date: Oct. 16, 2025

(54) SLOWER MODE TRANSITION SWITCH CONTROLLER

(71) Applicant: SKYWORKS SOLUTIONS, INC., Irvine, CA (US)

(72) Inventor: Bang Li Liang, Ottawa (CA)

(21) Appl. No.: 19/175,068

(22) Filed: Apr. 10, 2025

Related U.S. Application Data
(60) Provisional application No. 63/632,822, filed on Apr. 11, 2024.

(51) Int. Cl. H04B 1/44; H04B 1/401

(52) U.S. Cl. CPC H04B 1/44; H04B 1/401

(57) ABSTRACT

A system for selectively switching between a transmit mode and a receive mode, the system including one or more first switches; a controller configured to provide a control signal indicating a time to switch the system between the transmit mode and the receive mode; and a circuit configured to detect a rising edge of the control signal, detect a falling edge of the control signal, responsive to detecting the rising edge of the control signal, raising a first gate voltage of the one or more first switches to a high voltage, responsive to detecting the falling edge of the control signal, lowering the first gate voltage to a low voltage, and responsive to lowering the first gate voltage to the low voltage, raising the first gate voltage to an idle voltage, the idle voltage being less than the high voltage and greater than the low voltage.

### CROSS-REFERENCE TO RELATED APPLICATIONS

This application claims priority under 35 U.S.C. § 119 (e) to U.S. Provisional Patent Application 63/632,822, titled “Slower Mode Transition Switch Controller,” filed on Apr. 11, 2024, which is hereby incorporated by reference in its entirety for all purposes.

### BACKGROUND

### 1. Field of the Disclosure

At least one example in accordance with the present disclosure relates generally to switching devices for communication systems such as those configured to transmit and receive signals.

### 2. Discussion of Related Art

Communication systems, such as front-end modules for wireless telecommunications, may use switches to determine whether to operate in a receive or transmit mode of operation.

### SUMMARY

According to at least one aspect of the present disclosure a system for selectively switching between a transmit mode and a receive mode is presented, the system comprising: one or more first switches; a controller configured to provide a control signal indicating a time to switch the system between the transmit mode and the receive mode; and a circuit configured to detect a rising edge of the control signal, detect a falling edge of the control signal, responsive to detecting the rising edge of the control signal, raising a first gate voltage of the one or more first switches to a high voltage, responsive to detecting the falling edge of the control signal, lowering the first gate voltage to a low voltage, and responsive to lowering the first gate voltage to the low voltage, raising the first gate voltage to an idle voltage, the idle voltage being less than the high voltage and greater than the low voltage.

In some examples, the circuit includes at least one level shifter configured to provide the first gate voltage and configured to selectively provide the high voltage, low voltage, or idle voltage as the first gate voltage. In some examples, the circuit includes at least one edge detector configured to detect rising and falling edges of the control signal. In some examples, the circuit includes a first level shifter, a second level shifter, and a third level shifter, the first level shifter being configured to provide a first output signal based on the control signal, the second level shifter being configured to provide a second output signal based on the first output signal, and the third level shifter configured to provide a third output signal based on the first output signal and the second output signal. In some examples, the first output signal is configured to control a first switching device, and the second output signal is configured to control a second switching device. In some examples, responsive to the first switching device being closed, the low voltage is provided to the third level shifter. In some examples, responsive to the second switching device being closed, the idle voltage is provided to the third level shifter. In some examples, the idle voltage is a reference voltage for the circuit. In some examples, the system further comprises one or more second switches, the second switches having a lower capacitance than the first switches. In some examples, the one or more first switches are coupled to a transmit input of the system, and the one or more second switches are coupled to a receive input of the system. In some examples, the one or more first switches are coupled in series with the transmit input between the transmit input and an antenna connection, and wherein the one or more second switches are coupled in shunt with respect to the receive input and a reference node.

According to at least one aspect of the present disclosure, a telecommunication system is presented, the system comprising an antenna connection; a transmit input; a receive input; a reference node; one or more first switches coupled between the antenna connection and the transmit input; one or more second switches coupled between the receive input and the reference node; a controller configured to detect a rising edge of a control signal; detect a falling edge of the control signal; responsive to detecting the rising edge of the control signal, raising a gate voltage of the one or more first switches and the one or more second switches to a high voltage, responsive to detecting the falling edge of the control signal, lowering a gate voltage of the one or more first switches and the one or more second switches to a low voltage; responsive to lowering the gate voltage to the low voltage, raising the gate voltage to an idle voltage, the idle voltage being less than the high voltage and greater than the low voltage.

In some examples, the system further comprises a transmit capacitor coupled between the one or more first switches and the transmit input. In some examples, the system further comprises a receive capacitor coupled between the one or more second switches and the receive input. In some examples, the system further comprises an inductor coupled between the one or more first switches and the one or more second switches. In some examples, the system further comprises a reference capacitor coupled between the inductor and the reference node. In some examples, the system further comprises an antenna capacitor coupled between the antenna connection and the one or more first switches, the reference capacitor, and the inductor. In some examples, the one or more second switches have a lower capacitance than the one or more first switches.

According to at least one aspect of the present disclosure, a method for controlling switches in a telecommunication system is presented, the method comprising detecting an edge of a control signal, the control signal being configured to determine an operating mode of the telecommunication system; responsive to detecting the edge, determining that the edge is one or a rising edge or a falling edge; responsive to determining that the edge is a rising edge, increasing a gate voltage of at least one switch coupled between an antenna and a transmit input to a high voltage; responsive to determining that the edge is a falling edge, decreasing the gate voltage of the at least one switch to a low voltage; and responsive to decreasing the gate voltage, raising the gate voltage to an idle voltage, the idle voltage being between the high voltage and the low voltage.

In some examples, determining that the edge is a rising edge includes determining that a voltage of the control signal is greater than a first threshold voltage, and determining that the edge is a falling edge includes determining that the voltage of the control signal is below a second threshold voltage.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a topology for a telecommunications switch according to an example;

FIG. 2A illustrates a graph of a control signal according to an example;

FIG. 2B illustrates a graph of a gate voltage according to an example;

FIG. 2C illustrates a graph of a gate voltage according to an example;

FIG. 3 illustrates a table of performance characteristics of a telecommunication switching system according to an example;

FIG. 4 illustrates a topology for a telecommunications switch according to an example;

FIG. 5A illustrates a graph of a control signal according to an example;

FIG. 5B illustrates a graph of a gate voltage according to an example;

FIG. 6 illustrates a table of performance characteristics of a telecommunication switching system according to an example;

FIG. 7 illustrates a switching system according to an example;

FIG. 8 illustrates a process for modifying a gate voltage according to an example; and

FIG. 9 illustrates an edge detector according to an example.

### DETAILED DESCRIPTION

Telecommunication modules disclosed herein may use series and shunt switches to transfer the module between a transmit and a receive mode of operation. The series switches may be, in some examples, coupled between a transmit node and the antenna, where the TX signal (the signal to be transmitted) originates at the transmit node and is provided to the antenna. The series switches may be numerous depending on the electrical requirements (e.g., voltage, current, capacitance, inductance, and so forth) of the system. For example, there may be one, ten, twenty, fifty, or more transistors coupled together in series to operate as a switch between the transmit node and the antenna. In some examples, the series switch may be quite large comparatively speaking, with all the transistors (e.g., 10, 50, and so forth) occupying an area up to one or more square millimeters (though much smaller sizes are also possible). By comparison, the shunt switch may be relatively small, and may be composed of one or more transistors arranged in parallel and/or in series with one another between a receive node and a ground node.

Both the transmit and receive switches may have various electrical characteristics, such as capacitance, that affect the speed with which the switches can turn on and/or turn off. For example, the series switch may have a relatively large capacitance compared to the shunt switch. For a current to pass through a switch, the switch may need to be “charged,” that is, the switch may need to be charged to a point where it behaves like a short circuit. Charging the switch may correspond to turning the switch on. Likewise, the switch may hold a charge after being charged. The switch may be discharged by applying a voltage of the opposite polarity to it, thereby causing stored charge to leave the switch. The discharging process may be timed so that the amount of charge on a given switch is set to a desired level (e.g., equivalent to 1.2V, 0V, −1.2V, or any other value).

In some examples described herein, the switches are controlled by providing a bias, or idle, voltage, then providing an increased voltage during or after a rising edge is detected, and providing a lower voltage during or after a falling edge is detected. The bias voltage may be chosen such that it is higher than the reference voltage. In so doing, the difference between the increased voltage (the “on” voltage) and the bias voltage may be minimized, reducing turn-on time. Likewise, when turning off the switch, the difference between the lower voltage (the “off” voltage) and the bias voltage may be equal to or greater than the on voltage to cause a rapid discharging (and therefore deactivation) of the switch.

The timing requirements for applying the on and off voltages may be based upon the desired performance characteristics of the switches—for example, if a switch is intended to have a turn-on time of 1 μs, the off voltage may be maintained for 2 μs. The timing characteristics of the systems discussed herein will be examined in greater detail below.

In some examples discussed herein, both series and shunt switches may be controlled using the techniques described, however, in some examples discussed herein only the series or the shunt switch may be controlled using the techniques described. It is preferable, in some embodiments, to control the transmit switch as described herein (which may correspond to the series switch).

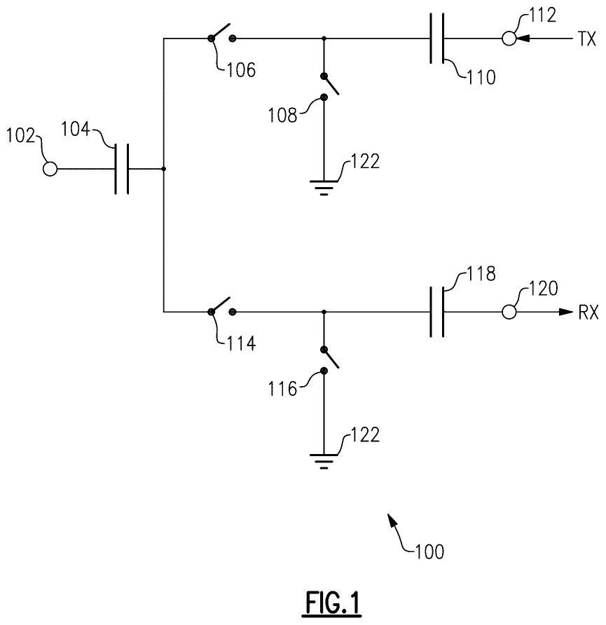

FIG. 1 illustrates a balanced telecommunication switch topology 100 (“topology 100”) according to an example. The topology 100 includes an antenna connection 102, an antenna capacitor 104, a first transmit switch 106, a second transmit switch 108, a transmit capacitor 110, a transmit node 112, a first receive switch 114, a second receive switch 116, a receive capacitor 118, a receive node 120, and a reference node 122.

The topology 100 is a balanced topology, meaning that the switches 106, 108, 114, 116 are arranged in a balanced manner. The first transmit switch 106 may be a series switch and the second transmit switch 108 may be a shunt switch. Likewise, in some examples the first receive switch 114 is a series switch and the second receive switch 116 is a shunt switch. The transmit switches 106, 108 may be designed to handle more powerful signals that the receive switches 114, 116. As a result, one or more of the transmit switches 106, 108 may be larger and therefore have a higher capacitance compared to one or more of the receive switches 114, 116.

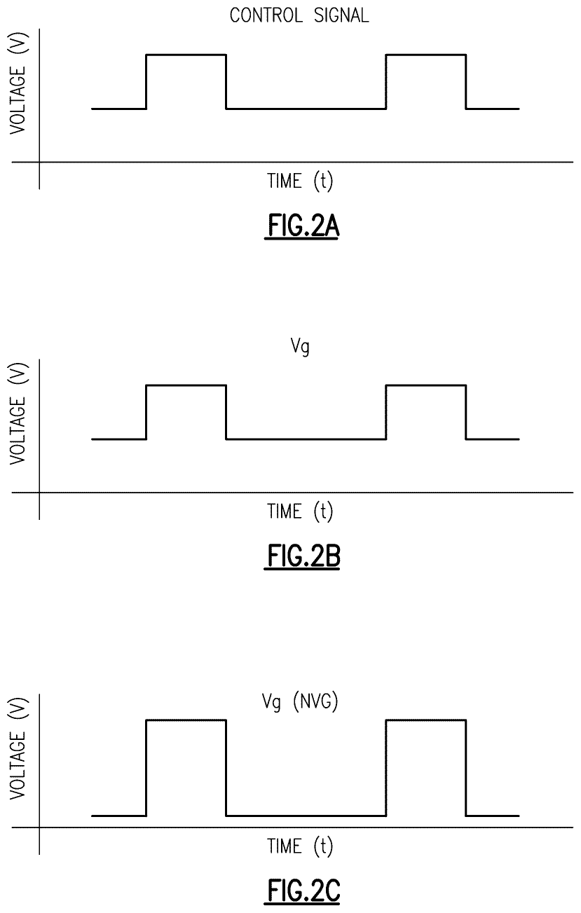

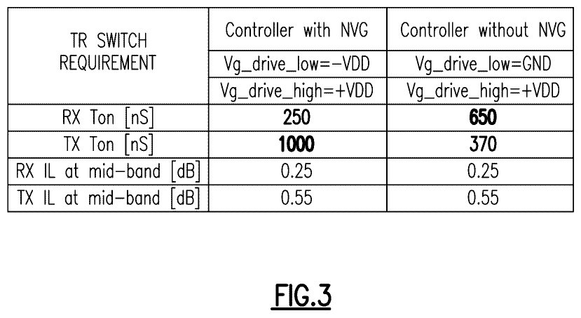

The switches 106, 108, 114, 116 are controlled using respective gate voltages (which may be the same or different for each of the switches). These control voltages (the gate voltages) will be discussed in greater detail with respect to FIGS. 2A-2C and FIG. 3.

The antenna connection 102 is coupled to the antenna capacitor 104. The antenna capacitor 104 is coupled to the first transmit switch 106 and the first receive switch 114. The first transmit switch 104 is coupled to the second transmit switch 108 and the transmit capacitor 110. The second transmit switch 108 is coupled to the reference node 122. The transmit capacitor 110 is coupled to the transmit node 112. The first receive switch 114 is coupled to the second receive switch 116 and the receive capacitor 118. The second receive switch 116 is coupled to the reference node 122. The receive capacitor 118 is coupled to the receive node 120. The transmit node 112 may be configured to receive a signal to be transmitted (a TX signal), and the receive node 120 may be configured to provide a signal that was received at the antenna (an RX signal).

When transmitting a signal, the first transmit switch 106 may be closed, the second transmit switch 108 may be open, the first receive switch 114 may be open, and the second receive switch 116 may be closed. As a result, a TX signal originating at the transmit node 112 may be routed from the transmit node 112 through the transmit capacitor 110, the first transmit switch 106, and the antenna capacitor 104 to the antenna connection 102 (and then to the antenna to be transmitted). The open second transmit switch 108 prevents the TX signal from being routed to the reference node 122 (e.g., ground). At the same time, the open first receive switch 114 prevents the TX signal from being routed to the receive node 120, and the closed second receive switch 116 ensures that signal present at the receive node 120 (or energy discharging the from the receive capacitor 118) is routed to the reference node 122 (e.g., ground). The first transmit switch 106 being closed provides a conducting path between the antenna connection 102 and the transmit node 112, in at least some examples.

When receiving a signal, the first transmit switch 106 may be open, the second transmit switch 108 may be closed, the first receive switch 114 may be closed, and the second receive switch 116 may be open. As a result, an RX signal received by the antenna may be routed through the antenna node 102, antenna capacitor 104, first receive switch 114, and receive capacitor 118 to the receive node 120 (and thence to any desired destination). The first transmit switch 106 being open prevents the RX signal from being routed to the transmit node 112 . . . . The second transmit switch 108 may be closed so that energy in the transmit capacitor 110 may be routed to the reference node 122 and/or signal present at the transmit node 112 may be routed to the reference node 122. The second receive switch 116 being open prevents the RX signal from being routed to the reference node 122, while the first receive switch 114 being closed provides a conducting path between the antenna connection 102 and the receive node 120, in at least some examples.

FIG. 2A illustrates a transmit control signal according to an example. The transmit control signal indicates when the topology 100 should be in a transmit mode of operation. Specifically, when the voltage is high the topology 100 should be configured to transmit the TX signal, and when the voltage is low, the topology 100 should be configured to receive the RX signal. The transmit control signal, in turn, controls what the gate voltage provided to the switches is.

FIG. 2B illustrates the gate voltage (Vg) provided to the switches according to an example. The high voltage is provided when the transmit control signal is high, and the low voltage is provided when the transmit control signal is low. The low voltage, in some examples, may be zero or may be the voltage at the reference node 122 of FIG. 1.

FIG. 2C illustrates the gate voltage (Vg) provided to the switches according to an example. In some examples, Vg illustrated in FIG. 2C corresponds to a negative gate voltage (NVG) mode of operation. The high voltage is provided when the transmit control signal is high, and the low voltage is provided when the transmit control signal is low. In contrast to FIG. 2B, the low voltage in FIG. 2C is lower (though the high voltage may be the same as in FIG. 2B). Thus, the difference between the high voltage and low voltage in FIG. 2C is greater than the difference between the high and low voltages in FIG. 2B. In some examples, the low voltage may be less than zero.

FIG. 3 illustrates a table showing the difference in performance between the switches of the topology 100. The data contained in FIG. 3 has been obtained experimentally and normalized to 1000 ns as the maximum value. RX Tₒₙ (ns) is the turn-on time of the receive switches in nanoseconds (ns). TX Tₒₙ (ns) is the turn-on time of the transmit switches in nanoseconds. RX IL at mid-band (dB) is the attenuation, for example due to insertion loss, of the receive switches in decibels, while the TX IL at mid-band (dB) is the attenuation (e.g., due to insertion loss) of the transmit signals in decibels. Both measures of attenuation (RX IL and TX IL) are considered based on mid-band frequencies.

The switch turn-on times may be with respect to any of the transmit and receive switches, as appropriate. For example, TX Tₒₙ may correspond to the first transmit switch 106 and/or second transmit switch 108. Likewise, RX Tₒₙ may correspond to the first receive switch 114 and/or second receive switch 116.

As represented, the voltage range for the Controller with NVG column is −VDD to +VDD, where +VDD is the highest voltage in the system or the highest voltage available to the circuit which provides Vg to the switches. In the Controller without NVG column, GND corresponds to the voltage of the reference node 122 (e.g., zero) and +VDD corresponds to the highest voltage in the system or available to the circuit which provides Vg to the switches.

Where the controller includes NVG, the turn-on time for the receive switches is 250 ns and the turn-on time for the transmit switches is 1000 ns. The receive switch attenuation is 0.25 dB and the transmit switch attenuation is 0.55 dB. Thus, the turn-on time for the transmit switches is nearly four times higher than that of the receive switches. In general, for the topology 100 and similar topologies (e.g., balanced switching topologies), the turn-on time for the transmit switches will generally be higher than the turn-on time for the receive switches.

When the controller does not include NVG (e.g., is not providing a negative Vg), the receive switch turn-on time is 650 ns and the transmit switch turn-on time is 370 ns, while the attenuation for the switches is identical to the attenuation with NVG as described above.

In some examples, it may be desirable to reduce the turn-on times below a threshold turn-on time or to reduce the receive turn-on times below a receive threshold and the transmit turn-on times below a transmit threshold. However, the balanced topology 100 may not be able to provide the desired turn-on times in either NVG mode or normal mode (e.g., without NVG).

As discussed above, the reason for the turn-on times being different is due to the charging and discharging of the switches 106, 108, 114, 116. The transmit switches 106, 108 may have higher capacitance and thus may take longer to charge (and come on) when a negative Vg is present because the transmit switches 106, 108 may have been pulled down to a negative voltage much lower than the reference node 122 voltage. Thus, when a negative Vg is applied the transmit switches 106, 108 may need to charge from −VDD to +VDD instead of from 0 to +VDD. As the former range is greater than the latter range, the turn-on time of the transmit switches 106, 108 increases.

By contrast, the receive switches 114, 116 may turn on faster when going from +VDD to −VDD because the receive switches 114, 116 may be configured to turn on at or near the reference voltage (e.g., 0). Thus, the larger drop from +VDD to −VDD may correspond to a faster discharging of the receive switches 114, 116 and thus the receive switches 114, 116 reaching their respective turn-on voltage faster. In essence, the drop to −VDD creates a larger negative bias voltage which forces the receive switches 114, 116 to discharge and switch over faster.

Without a negative Vg (e.g., in the normal mode), the opposite performance characteristics may be present compared to the NVG mode. Now, because the difference between 0 (e.g., the reference voltage) and +VDD is less than the difference between −VDD and +VDD, the transmit switches 106, 108 may be charged faster and turn on faster. However, because the difference between +VDD and 0 is less than the difference between +VDD and −VDD, the receive switches 114, 116 may discharge slower relative to the NVG mode.

The result of the above is that, in some examples, the receive switches will turn on faster than the transmit switches (e.g., those with NVG), and in other examples (e.g., those without NVG) the transmit switches will turn on faster than the receive switches. However, in both examples, the turn-on times for at least one of the receive switches and/or transmit switches may exceed a desired threshold turn-on time (e.g., the threshold turn-on time, the receive threshold, and/or the transmit threshold).

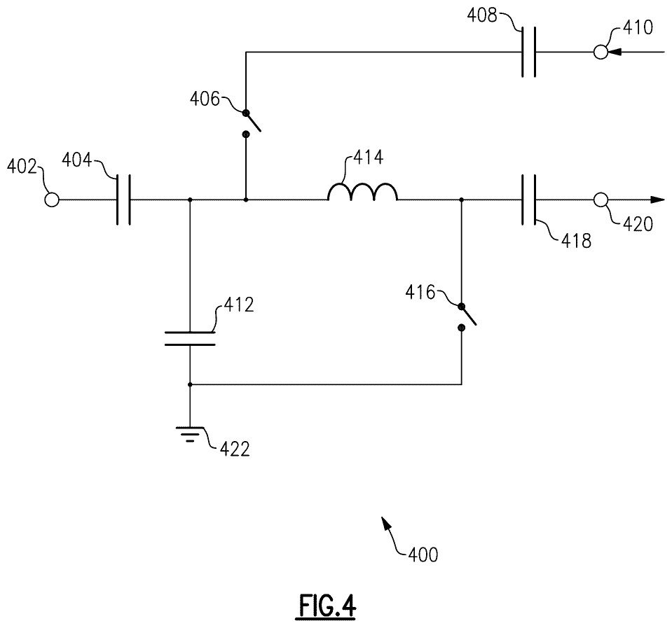

As will further be discussed below, a similar analysis as the above also applies to FIG. 4. That is, the discussion of FIGS. 2A-2C and FIG. 3 apply also to the series switch 406 and shunt switch 416 of FIG. 4, with the series switch 406 corresponding to the transmit switch (e.g., first transmit switch 406) and the shunt switch corresponding to the receive switches 114, 116.

FIG. 4 illustrates an unbalanced telecommunication switch topology 400 (“topology 400”) according to an example. The topology 400 includes an antenna connection 402, antenna capacitor 404, series switch 406, transmit capacitor 408, transmit node 410, reference capacitor 412, inductor 414, shunt switch 416, receive capacitor 418, receive node 420, and reference node 422.

The topology 400 is unbalanced in that it is asymmetric and does not provide identical transmit and receive paths. The series switch 406 may be larger than the shunt switch 416 and/or have a higher capacitance than the shunt switch 416. As a result, as described with respect to FIGS. 2A-2C and FIG. 3, the series switch 406 may take longer to turn on than the shunt switch in the NVG mode and less time to turn on in the normal mode (e.g., without NVG).

The antenna connection 402 is coupled to the antenna capacitor 404. The antenna capacitor 404 is coupled to the reference capacitor 412, the series switch 406, and the inductor 414. The series switch 406 is coupled to the transmit capacitor 408, and the transmit capacitor 408 is coupled to the transmit node 410. The inductor 414 is coupled to the shunt switch 416 and the receive capacitor 418. The receive capacitor 418 is coupled to the receive node 420. The reference node 422 is coupled to the reference capacitor 412 and to the shunt switch 416.

In the topology 400, when the series switch 406 is closed the shunt switch 416 may be closed as well. As a result, a conducting path is provided from the antenna connection 402 to the antenna capacitor 404 through the series switch 406 and transmit capacitor to the transmit node 410 so that signals may be transmitted from the transmit node along the conducting path to the antenna connected to the antenna connection 402. The closed shunt switch 416 routes signals from the receive node 420 (or that would be received by the receive node 420) to the reference node 422, thereby preventing the transmitted signal from appearing at the receive node 420.

When the series switch 406 and shunt switch 416 are open, the conducting path to the transmit node 410 is terminated and the route from the receive node 420 (through the receive capacitance 418 and shunt switch 416) to the reference node 422 is also terminated. As a result, signals received at the antenna now have a conducting path from the antenna connection 402, through the antenna capacitance 404, inductor 414, and receive capacitance 418, to the receive node 420.

Note that both the series switch 406 and shunt switch 416 are open in the receive mode and closed in the transmit node, meaning that these switches are turned on and off together in at least some examples. In some embodiments, the turn-on time of both switches may be kept below a threshold turn-on time (or respective series or shunt turn-on threshold) to meet certain design specifications that may vary by application.

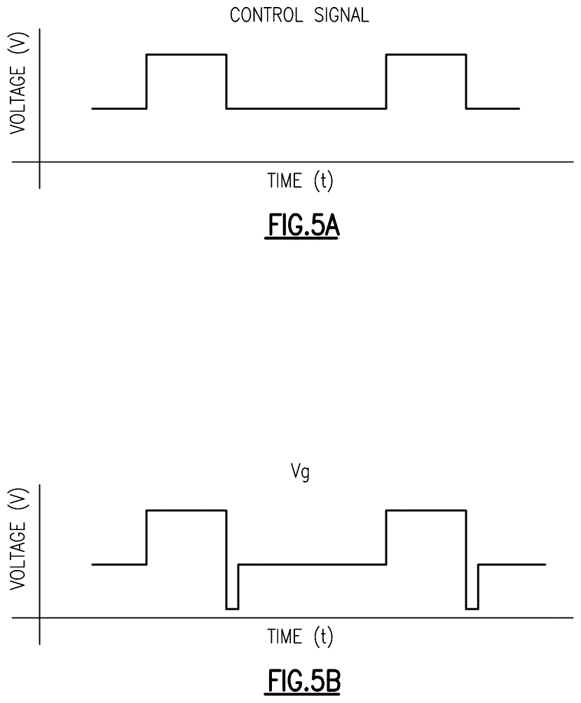

FIGS. 5A and 5B illustrate a gate control signal and a gate voltage (Vg) according to an example.

FIG. 5A illustrates a control signal having a high voltage and a low voltage. In some examples, when the control signal voltage is high, the topology 400 is in transmit mode, and when the control signal voltage is low, the topology 400 is in receive mode.

FIG. 5B illustrates an edge boost mode according to an example. Vg is provided to the switches 406, 416. The Vg has an idle voltage, a high voltage, and a low voltage. The idle voltage is between the high and low voltage. The high voltage may be +VDD and the low voltage may be −VDD. The idle voltage may be the reference voltage at the reference node 422 (e.g., 0V).

When the control signal of FIG. 5A goes high, the rising edge is detected and Vg goes high (e.g., to +VDD). When the control signal of FIG. 5A goes low, the falling edge is detected and Vg goes low (e.g. to −VDD). After a short period of time (e.g. 0.1 times, 0.5 times, 1 time, 2 times, and forth, the threshold turn-on time), Vg returns to the idle voltage. The Vg of FIG. 5B therefore combines some of the effects of the normal and NVG modes described with respect to FIGS. 2A-2C and FIG. 3. In particular, the switches 406, 416 will have shorter turn-on times, and the turn-on times will, on average, be less than the turn-on times of the earlier examples.

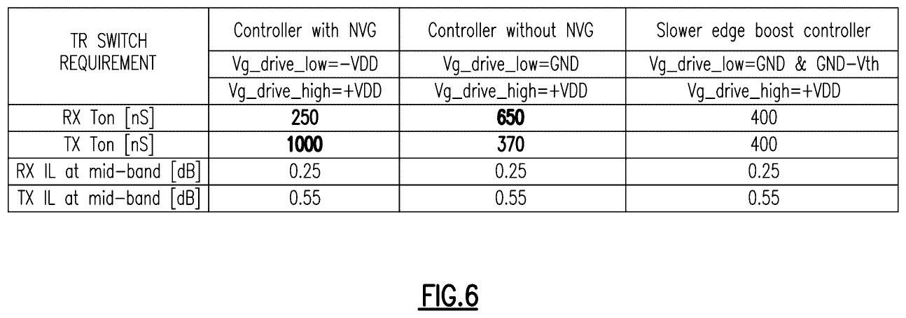

FIG. 6 illustrates a table showing the differences between applying the Vg of the normal and NVG modes of FIGS. 2A-2C and applying the Vg of FIG. 5B. There are now three columns, one corresponding to the NVG mode (Controller with NVG), one corresponding to the normal mode (Controller without NVG), and one corresponding to the edge boost mode of FIG. 5B (Slower edge boost controller). With the exception of the new column for the edge boost mode, FIG. 6 is identical to FIG. 3 and the meanings are all the same.

In the edge boost mode, the turn-on times for the transmit and receive switches, or the series and shunt switches, are identical: they are both 400 ns. That is, both RX Tₒₙ (ns) and TX Tₒₙ (ns) are identical. The attenuation remains identical to the attenuation of the NVG and normal modes even in the edge boost mode.

The edge boost mode, in some examples, provides the turn-on time from the reference voltage to +VDD because when turning on the series and/or shunt switches, the difference between the on-voltage and the idle voltage is relatively low. Likewise, when turning off the series and/or shunt switches, the difference between +VDD and −VDD is relatively large (compared to going from reference voltage to +VDD), and so the benefits of the NVG mode may be realized. However, there is a trade-off in some examples where the turn-on times are both slightly longer than they would be using the NVG mode or the normal mode for one of the switches. That is, in the NVG mode the receive turn-on time would be lower than in the edge boost mode, while in the normal mode the transmit turn-on time would be lower than in the edge boost mode. Nevertheless, the edge boost mode avoids the relatively long turn-on times for the transmit switches in the NVG mode and the relatively long turn-on times for the receive switches in the receive mode. Furthermore, in the edge boost mode, the turn-on times for both the transmit and receive switches (or the series and shunt switches) are below the threshold turn-on time (or receive threshold, or transmit threshold times). As a result, in some examples, the edge boost mode results in lower average turn-on times across both switch groups compared to the NVG or normal modes.

As with FIGS. 2A-2C and FIG. 3, the discussion of FIGS. 5A-5B and FIG. 6 apply to both the topology 100 of FIG. 1 and the topology 400 of FIG. 4.

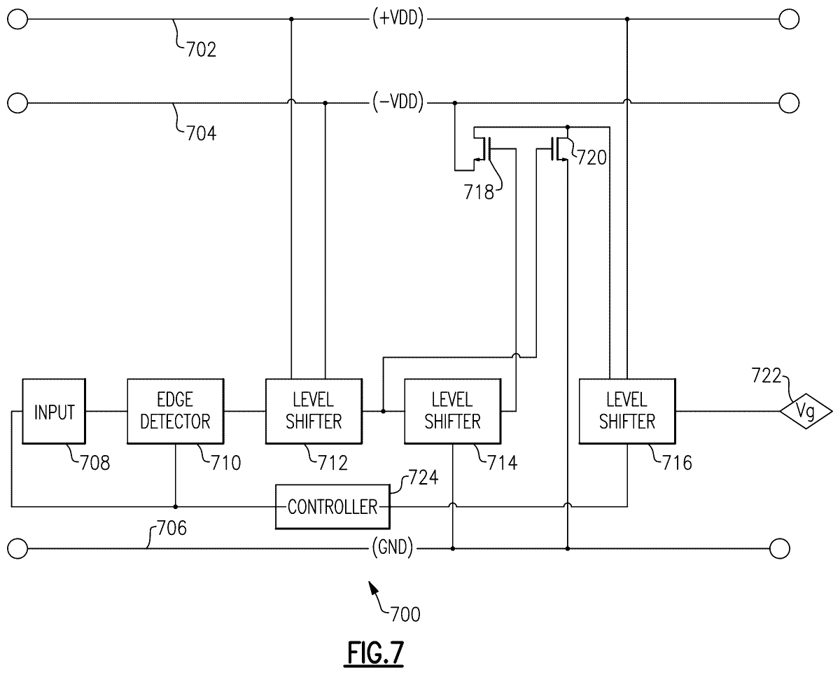

FIG. 7 illustrates a level shifting circuit 700 (“circuit 700”) for providing Vg to the gate of a transistor (or to the gates of multiple transistors), according to an example. The circuit 700 includes a high voltage rail 702 (“positive rail 702”), a low voltage rail 704 (“negative rail 704”), reference voltage rail 706 (“reference rail 706”), an input 708, an edge detector 710, a first level shifter 712, a second level shifter 714, a third level shifter 716, a first transistor 718, a second transistor 720, a gate voltage node 722 (“Vg node 722”), and at least one controller 724 (“controller 724”).

The positive rail 702 is coupled to the first level shifter 712 and the third level shifter 716. The negative rail 704 is coupled to the first level shifter 712 and to the first transistor 718. The reference rail 706 is coupled to the second level shifter 714 and to the second transistor 720. The input 708 is coupled to the edge detector 710. The edge detector 710 is coupled to the first level shifter 712. The first level shifter 712 is coupled to the positive and negative rails 702, 704 (as mentioned above), to the second level shifter 714, and to the second transistor 720. The second level shifter 714 is coupled to the first transistor 718 and to the reference rail 706 (as mentioned above). The third level shifter 716 is coupled to the Vg node 722, to the first and second transistors 718, 720, and to positive rail 702 (as mentioned above). The first transistor 718 is coupled to the second transistor 720 as well.

In some examples, the drain of the first transistor 718 is coupled to the drain of the second transistor 720 and to the third level shifter 716. The gate of the first transistor 718 is coupled to the second level shifter 714. The source of the first transistor 718 is coupled to the negative rail 704. The gate of the second transistor 720 is coupled to the first level shifter 712, and the source of the second transistor 720 is coupled to the reference rail 706.

The positive rail 702 provides the high voltage, e.g., +VDD. The negative rail 704 provides the low voltage, e.g., −VDD. The reference rail 706 provides the reference voltage (e.g., 0V). The reference voltage is, in some examples, less than +VDD and greater than −VDD.

The input 708 is configured to receive the control signal (e.g., the control signal of FIG. 2A or 5A) provided by the controller 724, for example via one or more busses, and to verify whether the control signal is high or low, for example by cleaning up the control signal or measuring the control signal to determine whether the control signal voltage is above the threshold voltage defining the high voltage range, below the threshold voltage defining the low voltage range, or between those voltages in an indeterminate range of voltages. The input 708 may, for example, be a comparator or Schmidt trigger. The input 708 is configured to provide a signal to the edge detector 710 indicative of the control signal.

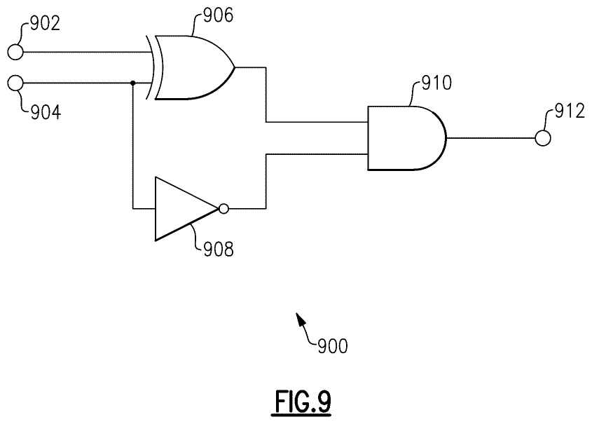

The edge detector 710 may, in some examples, be configured to receive the control signal as well (e.g., from the controller 724). Additionally, the edge detector 710 is configured to receive the signal from the input 708. Based on the signals it receives, the edge detector 710 is configured to detect whether a rising edge or falling edge has been detected, and then provides a signal to the first level shifter 712, where the characteristics of that signal differ based on whether a rising or falling edge was detected. An exemplary edge detector circuit is shown, for example, in FIG. 9, although it should be appreciated other types of edge detector circuits may alternatively be used.

The first level shifter 712 is configured to shift a level of Vg. The second level shifter 714 is configured to adjust a level of the signal provided by the first level shifter 712. The first and second transistor 718, 720 are configured to turn on or off based on the output of the first level shifter 712 or second level shifter 714. That is, when the first transistor 718 is closed (e.g., “on”) and the second transistor 720 is open (e.g., “off”), the voltage of the negative rail 718 is provided to the third level shifter 716. When the first transistor 718 is open (“off”) and the second transistor 720 is closed (“on”), the voltage of the reference rail 706 (e.g., 0V) is provided to the third level shifter 716.

The third level shifter 716 then provides either the voltage of the positive rail 702 (+VDD), or one of the voltage of the negative rail 704 or the voltage of the reference rail 706, to the Vg node 722. The level third level shifter 716 may also receive the control signal (e.g., from the controller 724, which may be used to determine which of the high voltage or one of the low or reference voltage is provided to the Vg node 722.

Thus, the circuit 700 uses the first two level shifters 714, 716, the transistors 718, 720, and the edge detector 710 to determine which of the three available voltage levels (high, low, and reference) to provide to the third level shifter 716, and the third level shifter 716 then provides the appropriate output voltage to the Vg node 722. The Vg node 722 may be connected to the gate of one or more transistors and thus the voltage provided to the Vg node 722 may control one or more switches (e.g., the series, shunt, transmit, and/or receive switches).

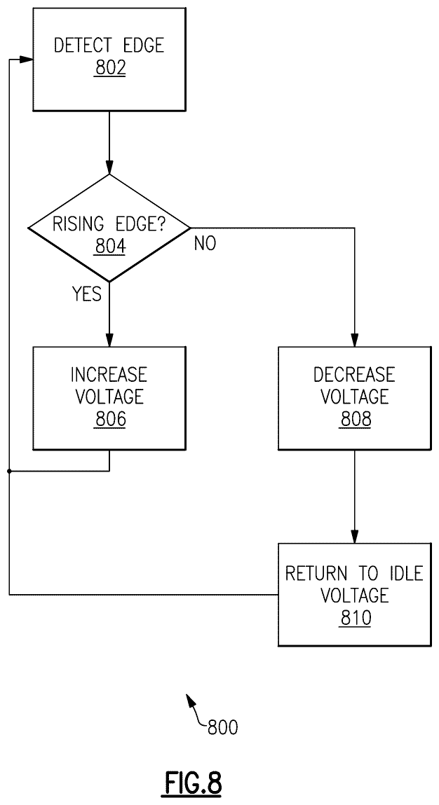

FIG. 8 illustrates a process 800 for controlling the gate voltage (Vg) of a switch according to an example. The process 800 will be discussed with reference to the circuit 700 of FIG. 7, however the process 800 is not limited to the circuit 700 of FIG. 7

At act 802, the circuit 700 detects an edge of the control signal. The control signal may be a signal, such as for example a transmit enable signal, that tells the circuit 700 to switch the voltage at the gate (or gates) of one or more transistors from one level to another level. The edge may be detected using an edge detector, such as the edge detector 710 of FIG. 7. The process 800 may then continue to act 804.

At act 804 the circuit 700 determines whether the edge is a rising edge or a falling edge (e.g., using the edge detector 710). If the circuit 700 determines the edge is a rising edge (804 YES), the process 800 continues to act 806. If the circuit 700 determines the edge is a falling edge, the process 800 continues to act 808.

At act 806, the circuit 700 has determined that a rising edge is present and increases the voltage. For example, the circuit 700 may use a level shifter (such as the third level shifter 716) to provide the high voltage (e.g., +VDD) to the gate (e.g., such that Vg=+VDD). The process 800 may then return to act 802.

Returning to act 804, if a falling edge is detected (804 NO), the process 800 continues to act 808. At act 808, the circuit 700 may reduce the voltage to a low voltage, such as the reference voltage of the reference rail 706 (e.g., 0V), or to the low voltage of the negative rail 704 (e.g., −VDD). In some examples, the circuit 700 reduces the voltage to the low voltage of the negative rail 704 for a set period of time. The process 800 may then continue to act 810.

At act 810, the circuit 700 provides idle voltage to the gates (e.g., Vg=the idle voltage). The idle voltage may be the reference voltage of the reference rail 706. The process 800 then returns to act 802.

FIG. 9 illustrates an edge detector 900 according to an example. The edge detector 900 includes a first input 902, a second input 904, an EXCLUSIVE-OR gate 906 (“XOR gate 906”), a NOT gate 908, an AND gate 910, and an output 912.

The first input 902 is coupled to the XOR gate 906. The second input 904 is coupled to the XOR gate 906 and the NOT gate 908. The XOR gate 906 is coupled to the AND gate 910. The NOT gate 908 is coupled to the AND gate 910. The AND gate 910 is coupled to the output 912.

The first input 902 provides a verified signal to the XOR gate 906. The verified signal may be based on an input signal that has been determined to be above (or below) a threshold voltage. The first input 902 may, for example, be the input 708 of FIG. 7.

The second input 902 provides an input signal to the XOR gate 906 and to the NOT gate 908. The input signal may not be verified, that is, the input signal may not be verified to be above (or below) a threshold voltage.

The XOR gate 906 is configured to provide an output when one and only one of the verified signal and input signal are above a threshold voltage. That is, for two input signals, the XOR gate 906 provides an output to the AND gate 910 only when either the verified signal or the input signal are high, and the other (of the verified signal and the input signal) is low.

In some examples, the NOT gate 908 may function as an inverter and may invert the voltage of the input signal (e.g., multiply the input signal voltage by negative one and then provide the inverted signal to the AND gate 910). In some examples, the NOT gate 908 may provide an output to the AND gate 910 when the input signal is below a threshold voltage. The AND gate 910 provides an output signal to the output 912 when both the NOT gate 908 and the XOR gate 906 are providing logical “high” signals to the AND gate 910.

As a result, when neither verified signal nor input signal is present, the output of the edge detector 900 is logical “low”—that is, there may be no output signal or the output signal may indicate that no edge is present. When both input signal and verified signal are present, the output of the edge detector 900 is logical “low” as well, indicating that no edge is present. In these examples, when neither signal is present this may represent when the input signal is low, while when both signals are present, this may indicate when the input signal is high and above a threshold voltage.

When the verified signal is present but the input signal is not, the output of the edge detector 900 is logical “high”—that is, there may be an edge present. When the input signal is present but the verified signal is not present, the output of the edge detector 900 is logical “high”-indicating that an edge may be present. In some examples, the input signal being present while the verified signal is not present may indicate a rising edge as the input signal may be increasing (e.g., ramping up) and may eventually exceed the threshold voltage needed to produce the verified signal. Likewise, when the verified signal is present but the input signal is not present, this may indicate a falling edge as the verified signal may still be high (e.g., due to propagation delay or timing delays), while the input signal is low (indicating that the voltage of the input signal has fallen below the threshold voltage corresponding to the verified signal).

In some examples, the input signal may be the control signal of FIG. 7.

In the foregoing discussion, the high voltage may be positive or negative, and the low voltage may be the opposite polarity of the high voltage. Different types of transistors (n-type, p-type, and so forth) may respectively use a negative or a positive voltage to turn on, and thus the polarities and relative values described herein are examples. The same systems and techniques could be used where +VDD is a negative value and −VDD is a positive value, for example.

While transistors are referred to throughout this specification, other types of switching devices (relays, throws, and so forth) may also be used. Wherever a transistor is referred to, a different type of switch may be used instead.

Switches are referred to in both singular and plural form. Both forms should be construed to mean singular and/or plural, as operating multiple switches in series or in parallel may be effectively the same as operating a single switch. Thus, a switch may be multiple switches, and multiple switches may be a switch.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as the controller 724 and/or circuit 700 may execute various operations discussed above. Using data stored in associated memory and/or storage, the controller 724 also executes one or more instructions stored on one or more non-transitory computer-readable media, which the controller 724 may include and/or be coupled to, that may result in manipulated data. In some examples, the controller 724 may include one or more processors or other types of controllers. In one example, the controller 724 is or includes at least one processor. In another example, the controller 724 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

1. A system for selectively switching between a transmit mode and a receive mode, the system comprising:
one or more first switches;
a controller configured to provide a control signal indicating a time to switch the system between the transmit mode and the receive mode; and
a circuit configured to
detect a rising edge of the control signal,
detect a falling edge of the control signal,
responsive to detecting the rising edge of the control signal, raising a first gate voltage of the one or more first switches to a high voltage,
responsive to detecting the falling edge of the control signal, lowering the first gate voltage to a low voltage, and
responsive to lowering the first gate voltage to the low voltage, raising the first gate voltage to an idle voltage, the idle voltage being less than the high voltage and greater than the low voltage.

2. The system of claim 1 wherein the circuit includes at least one level shifter configured to provide the first gate voltage and configured to selectively provide the high voltage, low voltage, or idle voltage as the first gate voltage.

3. The system of claim 1 wherein the circuit includes at least one edge detector configured to detect rising and falling edges of the control signal.

4. The system of claim 1 wherein the circuit includes a first level shifter, a second level shifter, and a third level shifter, the first level shifter being configured to provide a first output signal based on the control signal, the second level shifter being configured to provide a second output signal based on the first output signal, and the third level shifter configured to provide a third output signal based on the first output signal and the second output signal.

5. The system of claim 4 wherein the first output signal is configured to control a first switching device, and the second output signal is configured to control a second switching device.

6. The system of claim 5 wherein, responsive to the first switching device being closed, the low voltage is provided to the third level shifter.

7. The system of claim 5 wherein responsive to the second switching device being closed, the idle voltage is provided to the third level shifter.

8. The system of claim 1 wherein the idle voltage is a reference voltage for the circuit.

9. The system of claim 1 further comprising one or more second switches, the second switches having a lower capacitance than the first switches.

10. The system of claim 9 wherein the one or more first switches are coupled to a transmit input of the system, and the one or more second switches are coupled to a receive input of the system.

11. The system of claim 10 wherein the one or more first switches are coupled in series with the transmit input between the transmit input and an antenna connection, and wherein the one or more second switches are coupled in shunt with respect to the receive input and a reference node.

12. A system comprising:
an antenna connection;
a transmit input;
a receive input;
a reference node;
one or more first switches coupled between the antenna connection and the transmit input;
one or more second switches coupled between the receive input and the reference node;
a controller configured to
detect a rising edge of a control signal;
detect a falling edge of the control signal;
responsive to detecting the rising edge of the control signal, raising a gate voltage of the one or more first switches and the one or more second switches to a high voltage,
responsive to detecting the falling edge of the control signal, lowering a gate voltage of the one or more first switches and the one or more second switches to a low voltage;
responsive to lowering the gate voltage to the low voltage, raising the gate voltage to an idle voltage, the idle voltage being less than the high voltage and greater than the low voltage.

13. The system of claim 12 further comprising a transmit capacitor coupled between the one or more first switches and the transmit input.

14. The system of claim 13 further comprising a receive capacitor coupled between the one or more second switches and the receive input.

15. The system of claim 14 further comprising an inductor coupled between the one or more first switches and the one or more second switches.

16. The system of claim 15 further comprising a reference capacitor coupled between the inductor and the reference node.

17. The system of claim 16 further comprising an antenna capacitor coupled between the antenna connection and the one or more first switches, the reference capacitor, and the inductor.

18. The system of claim 16 wherein the one or more second switches have a lower capacitance than the one or more first switches.

19. A method for controlling switches in a telecommunication system, the method comprising:
detecting an edge of a control signal, the control signal being configured to determine an operating mode of the telecommunication system;
responsive to detecting the edge, determining that the edge is one or a rising edge or a falling edge;
responsive to determining that the edge is a rising edge, increasing a gate voltage of at least one switch coupled between an antenna and a transmit input to a high voltage;
responsive to determining that the edge is a falling edge, decreasing the gate voltage of the at least one switch to a low voltage; and
responsive to decreasing the gate voltage, raising the gate voltage to an idle voltage, the idle voltage being between the high voltage and the low voltage.

20. The method of claim 19 wherein determining that the edge is a rising edge includes determining that a voltage of the control signal is greater than a first threshold voltage, and determining that the edge is a falling edge includes determining that the voltage of the control signal is below a second threshold voltage.
